(19) United States
(12) Patent Application Publication
(10) Pub. No.: US 2010/0295968 A1
(43) Pub. Date: Nov. 25, 2010

(54) MEDIUM ADJUSTING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/538,840

(22) Filed: Aug. 10, 2009

(30) Foreign Application Priority Data
May 25, 2009 (CN) 200910302594.0

(51) Int. Cl. H04N 5/76; G06K 9/46

(52) U.S. Cl. 348/231.99; 382/190; 348/E05.031

(57) ABSTRACT

A medium adjusting system includes a displaying unit, an image capture unit, a processing unit, and a storage system. The image capture unit captures a number of viewer images. The storage system examines the number of viewer images to find faces in each viewer image, determines the speeds of viewers, the distances between the found faces and the displaying unit, and each viewer's gaze, and selects a medium content from the storage system correspondingly. The displaying unit displays the selected medium content.

### BACKGROUND

1. Technical Field

The present disclosure relates to a medium adjusting system and a medium adjusting method.

2. Description of Related Art

Conventional medium players cannot change features of movies, such as depth of field (DOF), when the medium players play the movies according to locations of the audience. As a result, it is lack of pleasure for entertainment.

### BRIEF DESCRIPTION OF THE DRAWINGS

FIG. 1 is a schematic block diagram of an exemplary embodiment of a medium adjusting system, the medium adjusting system includes a storage system.

FIG. 2 is a schematic block diagram of the storage system of FIG. 1.

FIG. 3 is a flowchart of an exemplary embodiment of a medium adjusting method.

### DETAILED DESCRIPTION

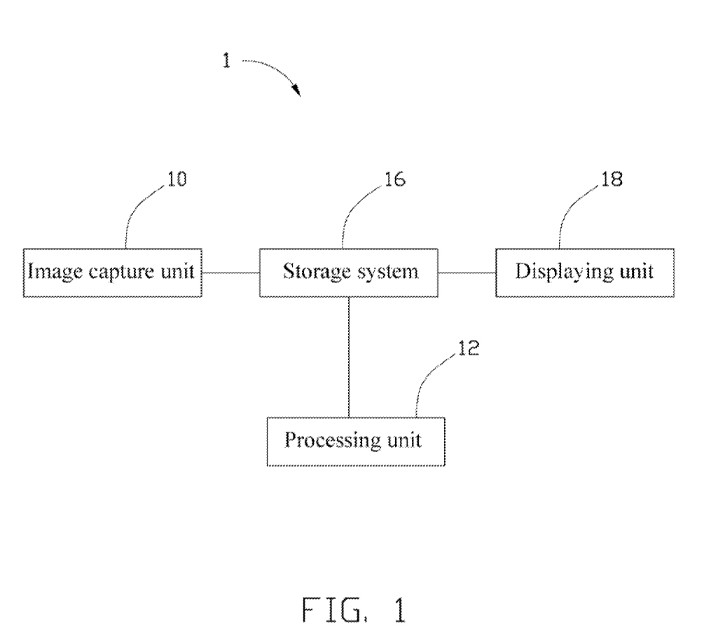

Referring to FIG. 1, an exemplary embodiment of a medium adjusting system 1 includes an image capture unit 10, a processing unit 12, a storage system 16, and a displaying unit 18. The medium adjusting system 1 is operable to process medium contents stored in the storage system 16, and display processed media to viewers.

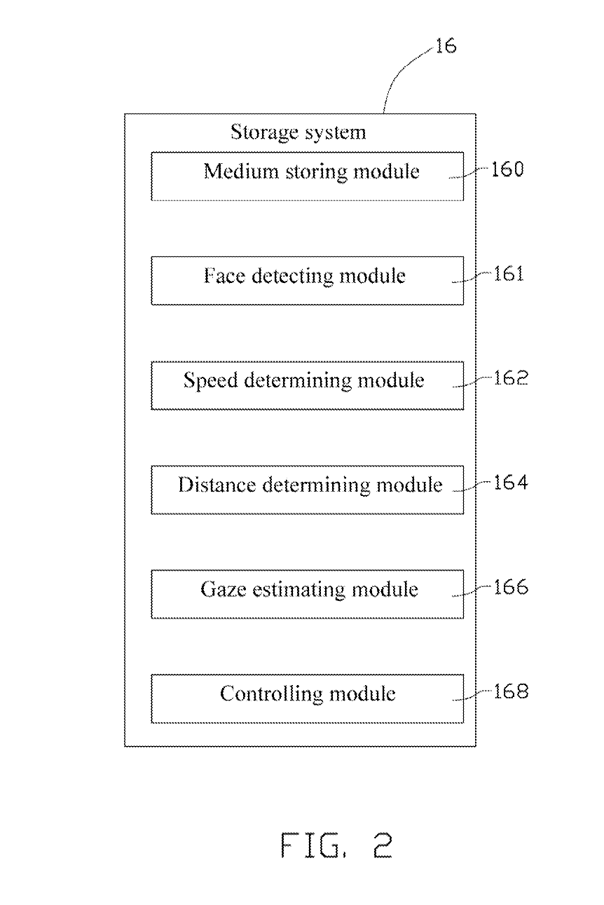

Referring to FIG. 2, the storage system 16 includes a medium storing module 160, a face detecting module 161, a speed determining module 162, a distance determining module 164, a gaze estimating module 166, and a controlling module 168. The face detecting module 161, the speed determining module 162, the distance determining module 164, the gaze estimating module 166, and the controlling module 168 may include one or more computerized instructions and are executed by the processing unit 14.

In the embodiment, the image capture unit 10 may be a camera. The displaying unit 18 may be an electronic billboard. The image capture unit 10 is located on the displaying unit 18. The image capture unit 10 captures a plurality of viewer images, and transmits the plurality of viewer images to the face detecting module 161.

The face detecting module 161 examines the plurality of viewer images to find faces in the plurality of viewer images, and to obtain information about the found faces. It can be understood that the face detecting module 161 uses well known facial recognition technology to find the faces in the plurality of viewer images and obtain information about the found faces. The information about the found faces may include coordinates of each found face in the plurality of viewer images, and locations of pupils of the found faces.

The medium storing module 160 stores a plurality of medium contents. In the embodiment, the plurality of medium contents may, for example, include two types of medium contents, such as medium contents for toys and razors. Each type of medium contents includes six video segments. The six video segments of each type have the same content, while different shooting angles and focusing distances. It can be understood that the video segments having different shooting angles means that a cameraman films the advertisements for toys or razors from three different shooting angles, such as 0°, 45° left side, and 45° right side. The video segments having different focusing distances means that the cameraman films the advertisement for toys or razors from two different distances, such as two meters and five meters.

As a result, twelve video segments are obtained. Six of the twelve video segments, which are called T1-T6, are the advertisements for toys. The other six of the twelve video segments, which are called R1-R6, are the advertisements for razors. The video segment T1 corresponds to an advertisement for toys with a shooting angle of 0° and a focusing distance of two meters. The video segment T2 corresponds to an advertisement for toys with a shooting angle of 0° and a focusing distance of five meters. The video segment T3 corresponds to an advertisement for toys with a shooting angle of 45° left side and a focusing distance of two meters. The video segment T4 corresponds to an advertisement for toys with a shooting angle of 45° left side and a focusing distance of five meters. The video segment T5 corresponds to an advertisement for toys with a shooting angle of 45° right side and a focusing distance of two meters. The video segment T6 corresponds to an advertisement for toys with a shooting angle of 45° right side and a focusing distance of five meters. The video segment R1 corresponds to an advertisement for razors with a shooting angle of 0° and a focusing distance of two meters. The video segment R2 corresponds to an advertisement for razors with a shooting angle of 0° and a focusing distance of five meters. The video segment R3 corresponds to an advertisement for razors with a shooting angle of 45° left side and a focusing distance of two meters. The video segment R4 corresponds to an advertisement for razors with a shooting angle of 45° left side and a focusing distance of five meters. The video segment R5 corresponds to an advertisement for razors with a shooting angle of 45° right side and a focusing distance of two meters. The video segment R6 corresponds to an advertisement for razors with a shooting angle of 45° right side and a focusing distance of five meters.

The displaying unit 18 can display one of the twelve video segments.

The speed determining module 162 receives the information about the found faces, and determines a speed of each viewer in the plurality of viewer images. For example, the speed determining module 162 compares two coordinates of the found face at two different times to get a distance that the found face moves. As a result, the speed determining module 162 makes a difference between the two different times divide the distance that the found face moves to get the speed of the found face. The speed of the found face denotes the speed of a viewer corresponding to the found face.

The speed determining module 162 further compares the speed of the found face with a predetermined speed. Upon the condition that the speed of the found face is greater than or equal to the predetermined speed, it may be understood that the viewer corresponds to the found face is not watching a video segment that the displaying unit 18 is displaying. In other words, the viewer corresponds to the found face is not interested in the video segment. Upon the condition that the speed of the found face is less than the predetermined speed, it may be understood that the viewer corresponds to the found face is interested in the video segment that the displaying unit 18 is displaying.

The controlling module 168 selects the type of the medium contents according to the speed of the found face. For example, it is supposed that the displaying unit 18 is displaying the video segment T1 now. Upon the condition that the speed of the found face is greater than or equal to the predetermined speed, it denotes that the viewer corresponds to the found face is not interested in the video segment that the displaying unit 18 is displaying. As a result, the controlling module 168 selects the medium contents for toys, which includes the six video segments R1-R6. Upon the condition that the speed of the found face is less than the predetermined speed, the controlling module 168 selects the medium contents for razors, which includes six video segments T1-T6.

The distance determining module 164 receives the information about the found faces, and determines a distance between each of the found faces and the displaying unit 18. For example, the distance determining module 164 processes the sizes of the found faces to obtain the distances between the found faces and the image capture unit 10. Because the image capture unit 10 is located on the displaying unit 18, the distance between the found faces and the image capture unit 10 is equal to the distance between the viewers corresponding to the found faces and the displaying unit 18. It can be understood that the distance determining module 164 uses well known technology to determine the distances between the found faces and the image capture unit 10 according to the sizes of the found faces.

The controlling module 164 further selects the video segments according to the distances between the found faces and the displaying unit 18. For example, upon the condition that the distance determining module 164 determines the distance between each of the found faces and the displaying unit 18 is greater than or equal to five meters, the controlling module 164 selects the video segments with focusing on a distance of five meters, such as the video segments T2, T4, T6, R2, R4, or R6.

The gaze estimating module 166 receives the information about the found faces, and determines each viewer's gaze in the plurality of viewer images. It can be understood that the gaze estimating module 166 uses well known technology, such as locating pupils of the viewer, to estimate the viewer's gaze in the viewer images.

The controlling module 168 further selects the video segments according to the viewer's gaze. For example, upon the condition that the gaze estimating module 166 determines the viewer's gaze is 45° left side, the controlling module 164 selects the video segments with shooting an angle of 45° left side, such as the video segments T3, T4, R3, or R4.

As described above, the controlling module 164 selects the types of the medium contents according to the speed of the found face at first, then selects the video segments according to the distances between the found faces and the displaying unit 18, and selects the video segments according to the viewers' gaze according to the gaze estimating module 166 lastly. As a result, a video segment which is selected the most repeatedly is selected finally. The finally selected video segment is transmitted to the displaying unit 18 to be displayed. For example, the controlling module 168 selects the six video segments R1-R6 according to the speeds of the found faces at first, selects the video segments T2, T4, T6, R2, R4, and R6 according to the distances between the found faces and the displaying unit 18, and selects the video segments T3, T4, R3, and R4 according to the viewers' gaze according to the gaze estimating module 166. Therefore, the video segment R4 is the selected finally.

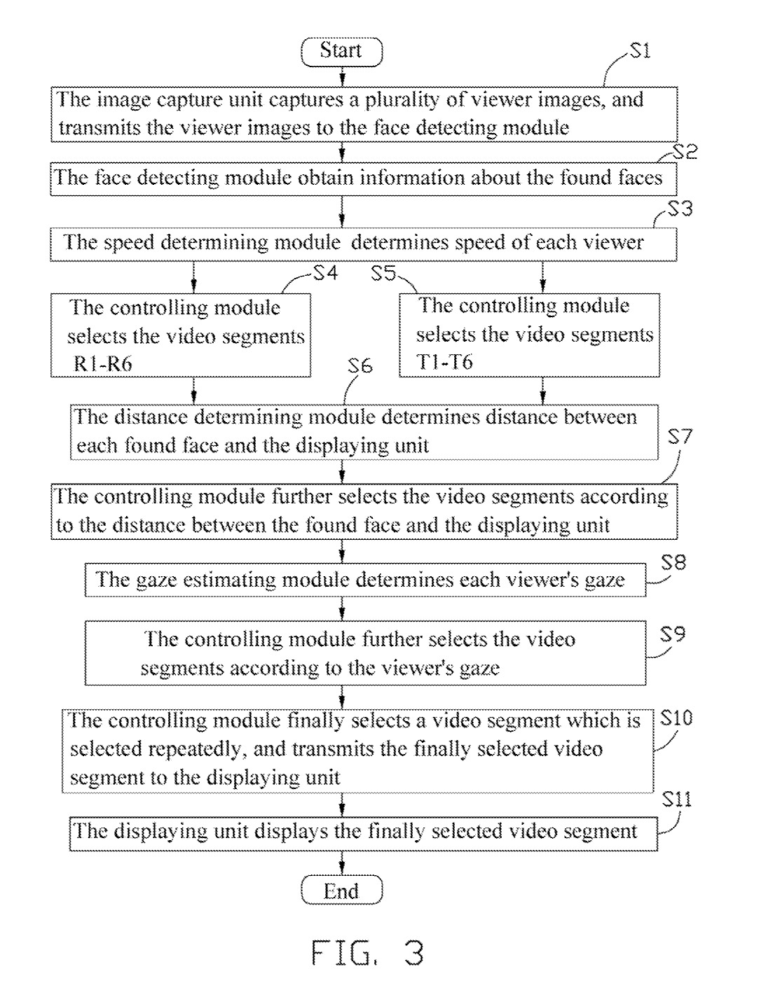

Referring to FIG. 3, an exemplary embodiment of a medium adjusting method includes the following steps. It is supposed that the displaying unit 18 is displaying the video segment T1 now.

In step S1, the image capture unit 10 captures a plurality of viewer images, and transmits the plurality of viewer images to the face detecting module 161.

In step S2, the face detecting module 161 examines the plurality of viewer images to find faces in the viewer images, and obtain information about the found faces. It can be understood that the face detecting module 161 uses well known facial recognition technology to find the faces in the viewer images and obtain information about the found faces. The information about the found faces may include coordinates of each found face in the plurality of viewer images, and locations of pupils of the found faces.

In step S3, the speed determining module 162 receives the information about the found faces, and determines a speed of each viewer in the plurality of viewer images. It can be understood that the speed determining module 162 may compare two coordinates of the found face at two different times to get a distance the found face moves at first, and then get the speed of the found face by making a difference between the two different time divide the distance that the found face moves. The speed determining module 162 further compares the speed of the found face with the predetermined speed. Upon the condition that the speed of the found face is greater than or equal to the predetermined speed, the flow goes to step S4. Upon the condition the speed of the found face is less than the predetermined speed, the flow goes to step S5.

In step S4, the controlling module 168 selects the medium contents for toys, which includes the six video segments R1-R6. The flow goes to step S6.

In step S5, the controlling module 168 selects the medium contents for razors, which includes six video segments T1-T6. The flow goes to step S6.

In step S6, the distance determining module 164 receives the information about the found faces, and determines a distance between each found faces and the displaying unit 18. It can be understood that the distance determining module 164 processes the size of each found faces to obtain the distance between the found face and the image capture unit 10.

In step S7, the controlling module 164 further selects the video segments according to the distance between each found face and the displaying unit 18. For example, if the distance determining module 164 determines the distances between the found faces and the displaying unit 18 is less than two meters, the controlling module 164 selects the video segments with a focusing distance of two meters, such as the video segments T1, T3, T5, R1, R3, or R5.

In step S8, the gaze estimating module 166 receives the information about the found faces, and determines each viewer's gaze in the plurality of viewer images. It can be understood that the gaze estimating module 166 uses well known technology, such as locating pupils of the viewer, to estimate the viewer's gaze in the viewer images.

In step S9, the controlling module 168 further selects the video segments according to the viewer's gaze. For example, if the gaze estimating module 166 determines the viewer's gaze is 0°, the controlling module 164 selects the video segments with shooting angle of 0°, such as the video segments T1, T2, R1, and R2.

In step S10, the controlling module 164 selects a video segment which is selected in the steps S4 or S5, S7, and S9 the most repeatedly, and transmits the selected video segment to the displaying unit 18. In the embodiment, if the speed of the found face is less than the predetermined speed, the controlling module 164 selects the video segment T1.

In step S11, the displaying unit 18 displays the selected video segment.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A medium adjusting system comprising:
an image capture unit to capture a plurality of viewer images;
a processing unit;
a storage system connected to the processing unit and storing one or more programs to be executed by the processing unit, wherein the storage system comprises:
a medium storing module to store a plurality of medium contents;
a face detecting module to examine the plurality of viewer images to find faces in the plurality of viewer images, and obtain information about the found faces;
a speed determining module to receive the information about the found faces, and determines speeds of viewers in the plurality of viewer images; and
a controlling module to select one of the plurality of medium contents according to the speeds of the viewers in the plurality of viewer images; and
a displaying unit to display the selected medium content according to the controlling module.

2. The medium adjusting system of claim 1, wherein the image capture unit is a camera.

3. A medium adjusting system comprising:
an image capture unit to capture a plurality of viewer images;
a processing unit;
a storage system connected to the processing unit and storing one or more programs to be executed by the processing unit, wherein the storage system comprises:
a medium storing module to store a plurality of medium contents, wherein the plurality of medium contents comprise a plurality of different types of medium contents, each type of medium contents comprises a plurality of video segments with different shooting angles and focusing distances;
a face detecting module to examine the plurality of viewer images to find faces in the plurality of viewer images, and obtain information about the found faces;
a speed determining module to receive the information about the found faces, and determines speeds of viewers in the plurality of viewer images; and
a controlling module to select one or more of the plurality of video segments according to the speeds of the viewers in the plurality of viewer images; and
a displaying unit to display the selected one or more of the plurality of video segments according to the controlling module.

4. The medium adjusting system of claim 3, wherein the storage system further comprises a distance determining module to receive the information about the found faces, and determines a distance between each found face and the displaying unit; wherein the controlling module is further to select one or more of the plurality of video segments according to the distances between the found faces and the displaying unit, the displaying unit is to display a video segment that the controlling module selects the most repeatedly according to the speeds of the viewers in the plurality of viewer images and the distances between the found faces and the displaying unit.

5. The medium adjusting system of claim 3, wherein the storage system further comprises a gaze estimating module to receive the information about the found faces, and determines each viewer's gaze in the plurality of viewer images; wherein the controlling module is further to select one or more of the plurality of video segments according to the viewer's gaze, the displaying unit is to display a video segment that the controlling module selects the most repeatedly according to the speeds of the viewers in the plurality of viewer images, the distances between the found faces and the displaying unit, and the viewer's gaze.

6. A medium adjusting method comprising:
capturing a plurality of viewer images;
examining the plurality of viewer images to find faces in the plurality of viewer images and obtaining information about the found faces;
receiving the information about the found faces and determining speeds of viewers in the plurality of viewer images;
selecting one of a plurality of medium contents according to the speeds of the viewers in the plurality of viewer images; and
displaying the selected medium content.

7. The medium adjusting method of claim 6, between the step of selecting one medium content and the step of displaying the selected medium content further comprising:
receiving the information about the found faces, and determines a distance between found faces and the displaying unit; and
selecting one of a plurality of medium contents according to the distances between the viewers and the displaying unit.

8. The medium adjusting method of claim 6, between the step of selecting one medium content and the step of displaying the selected medium content further comprising:
receiving the information about the found faces, and determines viewers' gaze; and
selecting one of a plurality of medium contents according to the viewers' gaze.
